(19) United States
(12) Patent Application Publication
(10) Pub. No.: US 2013/0291121 A1
(43) Pub. Date: Oct. 31, 2013

(54) Cloud Abstraction

(71) Applicants: Vlad Mircea Iovanov, Arad (RO); Mihai Buzgau, Arad (RO); Jawaid Ekram, Redmond, WA (US); Avinash Cavale, Sammamish, WA (US); Mohamed Jawad Khaki, Sammamish, WA (US)

(72) Inventors: Vlad Mircea Iovanov, Arad (RO); Mihai Buzgau, Arad (RO); Jawaid Ekram, Redmond, WA (US); Avinash Cavale, Sammamish, WA (US); Mohamed Jawad Khaki, Sammamish, WA (US)

(21) Appl. No.: 13/457,274

(22) Filed: Apr. 26, 2012

(51) Int. Cl. G06F 15/16; G06F 21/24

(52) U.S. Cl. 726/28; 709/217

(57) ABSTRACT

Disclosed is, among other things, techniques to allow optimal use of various cloud service providers. In one embodiment, this is done by providing an intermediate level service, a Cloud Abstractor, exposing an API that translates to the various provider cloud APIs. An application may call an API on the Cloud Abstractor, and the Cloud Abstractor will make calls to one or more clouds to perform the requested behavior.

### FIELD

This disclosure relates to techniques of abstracting clouds.

### BACKGROUND

Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. (“The NSIT Definition of Cloud Computing,” National Institute of Standards and Technology, September 2011).

Cloud services are available from different providers, often having differing advantages and disadvantages. Cloud computing providers may offer, for example, computation, software applications, data access, data management and storage resources. For example, one cloud provider may offer powerful database tools, but not have good application support, while another may have weaker database tools, but have inexpensive file storage. Clouds may also be private, for example if an enterprise operates a cloud to support its operations.

Selecting a cloud provider requires a commitment to that provider's application programming interfaces (APIs), architecture, security, services offered, downtime, and upgrade schedules.

Some cloud providers offer better performance or better pricing for particular services than others, which may require a developer to learn interfaces for each of the clouds they want to access.

Cloud providers generally provide one administrative login per cloud, and the user wishing to provide access to other users to the same cloud typically share passwords. There is no provision for different roles and access control. Furthermore these logins cannot be shared across cloud providers.

### SUMMARY

The instant application discloses, among other things, techniques to allow optimal use of various cloud service providers. In one embodiment, this is done by providing an intermediate level service, a Cloud Abstractor, exposing an API that maps to the various provider cloud APIs. An application may call an API on the Cloud Abstractor, and the Cloud Abstractor will make calls to one or more clouds to perform the requested behavior. For example, the Cloud Abstractor may be configured to submit calls for file storage to one cloud, while calls for database services are submitted to a different cloud.

### BRIEF DESCRIPTION OF THE DRAWINGS

FIG. 1 is an example of a system capable of supporting cloud management.

FIG. 2 is a diagram showing an example of data flow from a user device to one or more clouds.

FIG. 3 is an example of one embodiment of a translate operation.

FIG. 4 is an example of one embodiment of a security model.

FIG. 5 is an example of a security model for multiple users accessing a single zone.

FIG. 6 is an example of a security model for a single user accessing multiple zones.

FIG. 7 is an example of one embodiment of realms.

FIG. 8 illustrates a component diagram of a computing device according to one embodiment.

### DESCRIPTION OF THE INVENTION

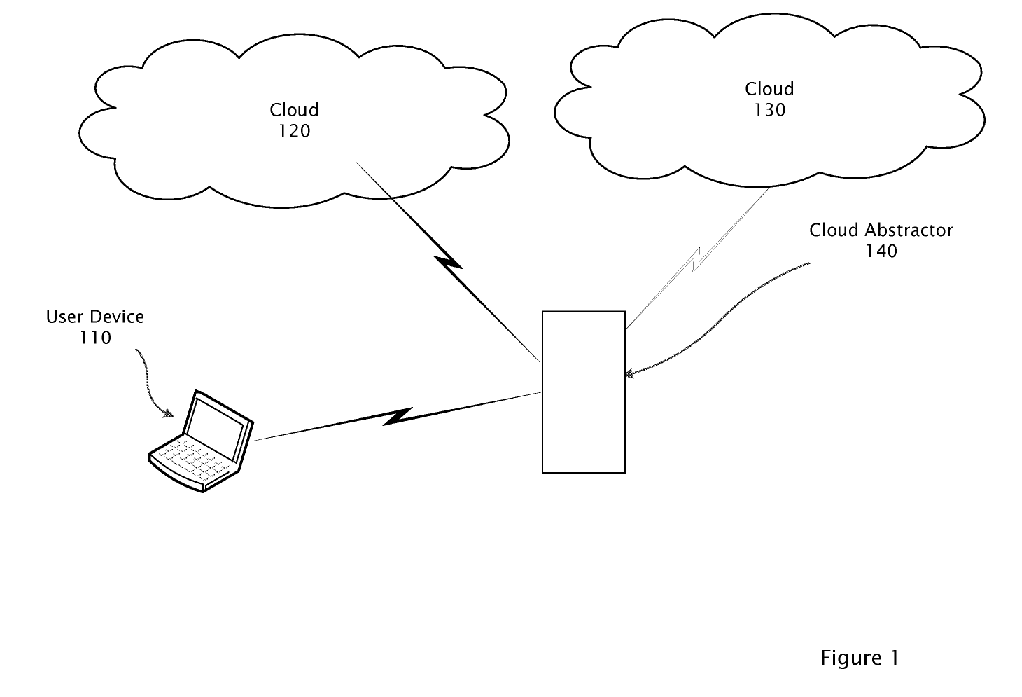

FIG. 1 is an example of a system capable of supporting cloud abstraction. User Device 110 may make API calls to Cloud Abstractor 140, which may then make calls to Cloud 120 and Cloud 130 to perform any requested actions. As an example, User Device 110 may request to store data on a database server. While both Cloud 120 and Cloud 130 may offer that service, it may be that Cloud 130 provides better database performance than Cloud 120, and Cloud Abstractor 140 may be configured to submit such requests to Cloud 130.

One skilled in the art will recognize that Cloud Abstractor 140 may be implemented in various embodiments, including but not limited to a computer, a farm of computers, a cloud, or many other configurations.

Many factors may influence a choice of which cloud to use, and the choice may vary depending on a situation. For example, in some situations, performance may be a primary consideration, while in others cost may be more important. Service benefits may vary with time, as well—it may be that nighttime computation is cheaper than daytime. Many factors may be considered—including, but not limited to, geographical location, pricing, performance, capacity, security, functionality, and ease of access. A Cloud Abstractor may be configured to use various clouds to ensure cost, performance, or other goals are obtained, while providing a consistent interface for applications to call so that changes in cloud preferences do not require developers to rewrite applications. Developers and users need not be aware of which cloud service is providing requested services. And if a new cloud becomes available which better suits a requirement of an application, Cloud Abstractor 140 may be configured to use services from the new cloud without changes to the application.

Cloud Abstractor 140 may also be configured to replicate any transactions to both Cloud 120 and Cloud 130, so that, for example, in the event of a failure of Cloud 120, a system could failover to Cloud 130 and continue operations.

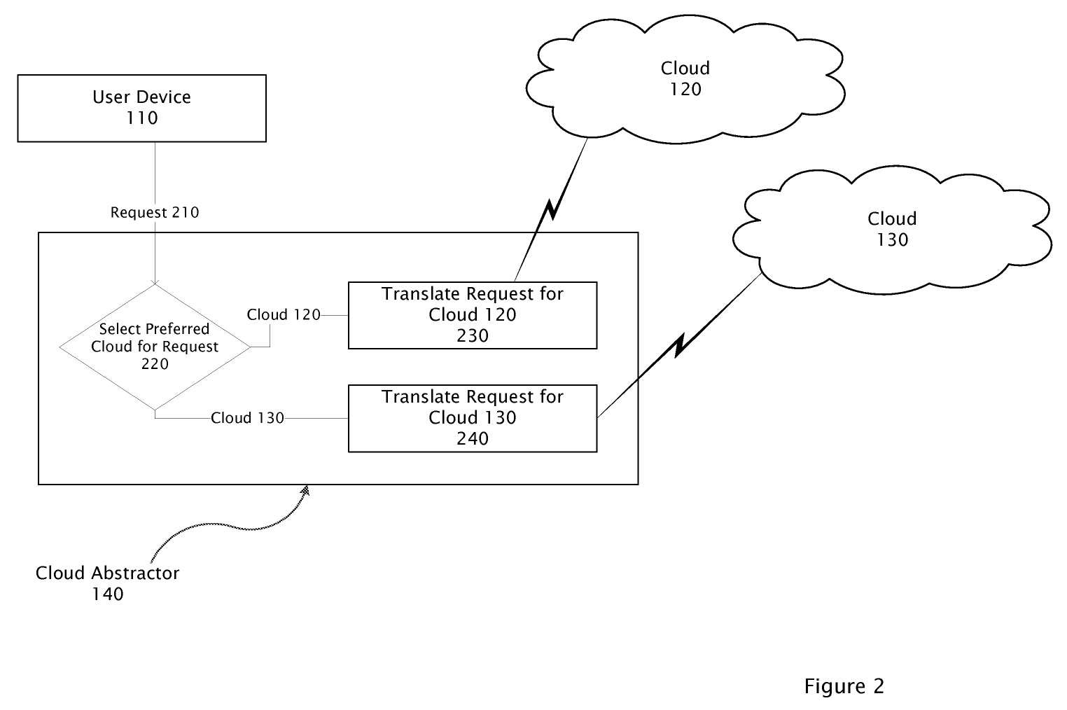

FIG. 2 is a diagram showing an example of data flow from a User Device 120 to one or more clouds. In one embodiment, User Device 110 may submit a Request 210 including a database operation and a file storage operation. Cloud Abstractor 140 may be configured to submit database operation requests to Could 120. Cloud Abstractor 140 may Translate the database operation Request for Cloud 120 230, and submit the request to Cloud 120. Cloud Abstractor 140 may also be configured to submit file storage operations to Cloud 130. Cloud Abstractor 140 may Translate the database operation Request for Cloud 130 240, and submit the request to Cloud 130.

In one embodiment, this may allow a company to use different clouds to support different applications, while a developer could be using one set of APIs for all of the different clouds. For example, one application may target Cloud 120 while another targets Cloud 130, but the developer may use APIs supported by Cloud Abstractor 140, which may translate any calls made to the appropriate API for the cloud being used. If it is desirable to change which cloud one of the application uses, Cloud Abstractor 140 may be reconfigured, and no changes are necessary to the application.

In another embodiment, one application may use services offered by different clouds. Cloud Abstractor 140 may be configured to pass calls for one service to one cloud, while calls for another service may be passed to another cloud. A consistent set of APIs may reduce the cost of development and maintenance for such an application.

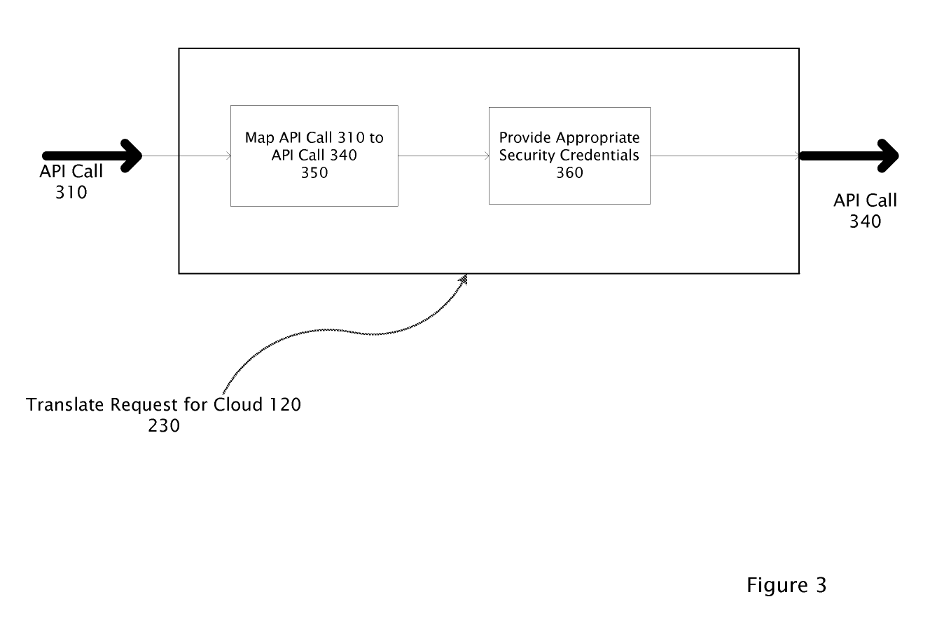

FIG. 3 is an example of one embodiment of a translate operation. In this example, an API Call 310 may be received when Cloud Abstractor 140 Selected Cloud 120 as the preferred cloud for a type of request as API Call 310. API Call 310 may be accompanied by information about the user or application making the call. Translate Request for Cloud 120 230 may translate API Call 310 to API Call 340 350, calling an appropriate API with proper parameters for Cloud 120 to process to perform an action indicated by API Call 310.

Translate Request for Cloud 120 230 may include receiving API Call 310 and analyzing it to determine the purpose of the call. After abstracting the information, an appropriate cloud to service the request may be determined, and an API Call 340 configured for submission to the determined cloud.

Information about the user or application making API Call 310 may also lead to Appropriate Security Credentials being Provided 360 to Cloud 120. Cloud Abstractor 140 may map multiple users to a single account on Cloud 120, providing security roles and an ability to track users which may not be available on Cloud 120.

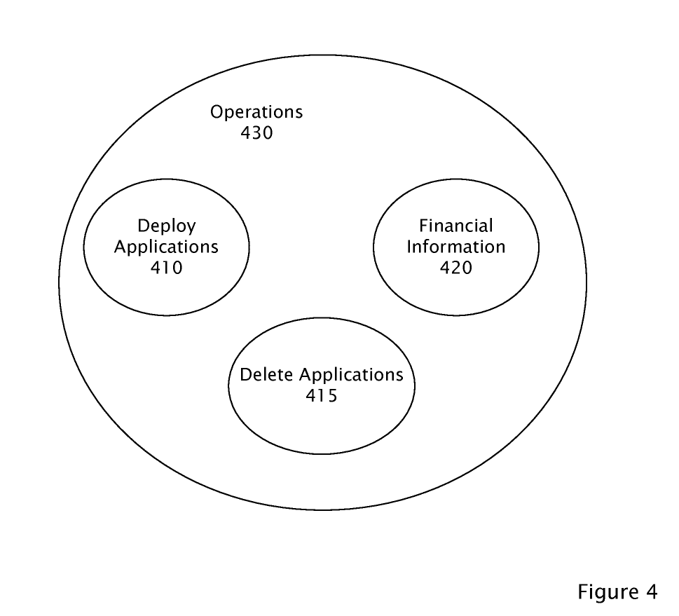

FIG. 4 is an example of one embodiment of a security model. This example may be used, for example, for a small company, with IT staff, such as developers, testers and operations, and billing staff. In this example, certain users or roles may have access to Deploy Applications 410, but not Delete Applications 415. Other users may have access to Financial Information 420, and an operations 430 role may have access to all three. Cloud Abstractor 140 may handle the security and allow appropriate actions to be taken irrespective of which cloud the application could be deployed in. The user may not need to login into multiple clouds individually as clouds provided by different vendors may not share security information. At the same time a cloud user may need not be aware where the database of the application resides as it may change from time to time based on the cost, performance, functionality , or other requirements of the application.

In one embodiment, Cloud Abstractor 140 may enforce roles and user-assignments so that application developers may focus on managing the application rather than on which credentials to use to login.

In another embodiment, Deploy Applications 410 and Delete Applications 420 may operate on one cloud, where applications are stored, while Financial Information 420 may be stored on a different cloud. Cloud Abstractor 140 may help hide complexities of configuration details from an application by providing a consistent set of APIs, and translating calls to the appropriate cloud for whichever operation is requested. The application may not need to be written with knowledge that it is accessing heterogeneous clouds.

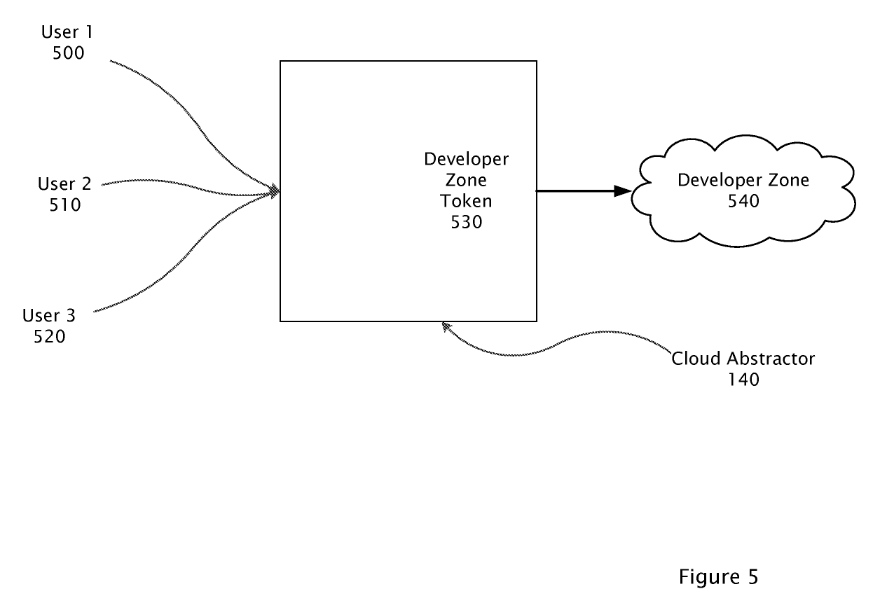

FIG. 5 is an example of a security model for multiple users accessing a single zone. A zone may comprise one or more clouds. In this example, User 1 500 may log into Cloud Abstractor 140 and be authenticated. Once Cloud Abstractor 140 Authenticates User 1 500, Cloud Abstractor 140 may generate a Developer Zone Token 530, allowing User 1 500 access to Developer Zone 540 without User 1 500 needing his or her own account for Developer Zone 540. Similarly, User 2 510 and User 3 520 may gain access to Developer Zone 540 without having personal accounts for it.

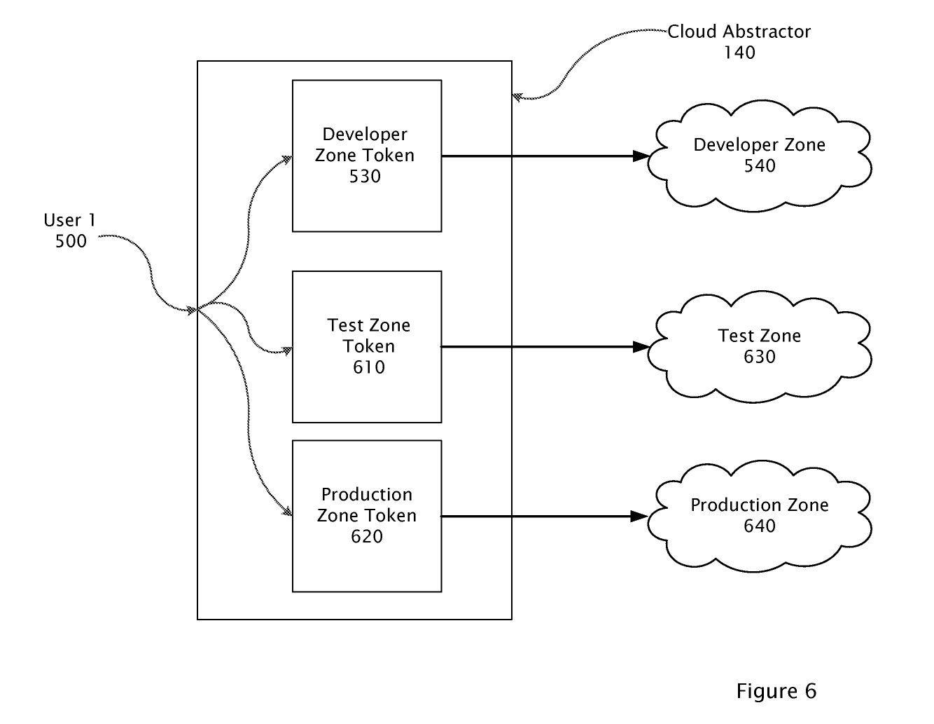

FIG. 6 is an example of a security model for a single user accessing multiple zones. In this example, User 1 500 may be authenticated on Cloud Abstractor 140, which may be configured to recognize that User 1 500 is allowed to access any of Developer Zone 540, Test Zone 630, or Production Zone 640. To facilitate access for User 1 500, Cloud Abstractor may generate security tokens such as Developer Zone Token 530, Test Zone Token 610, and Production Zone Token 620. This may allow User 1 500 to gain access to the various zones without having to log in directly to each one User 1 wishes to access.

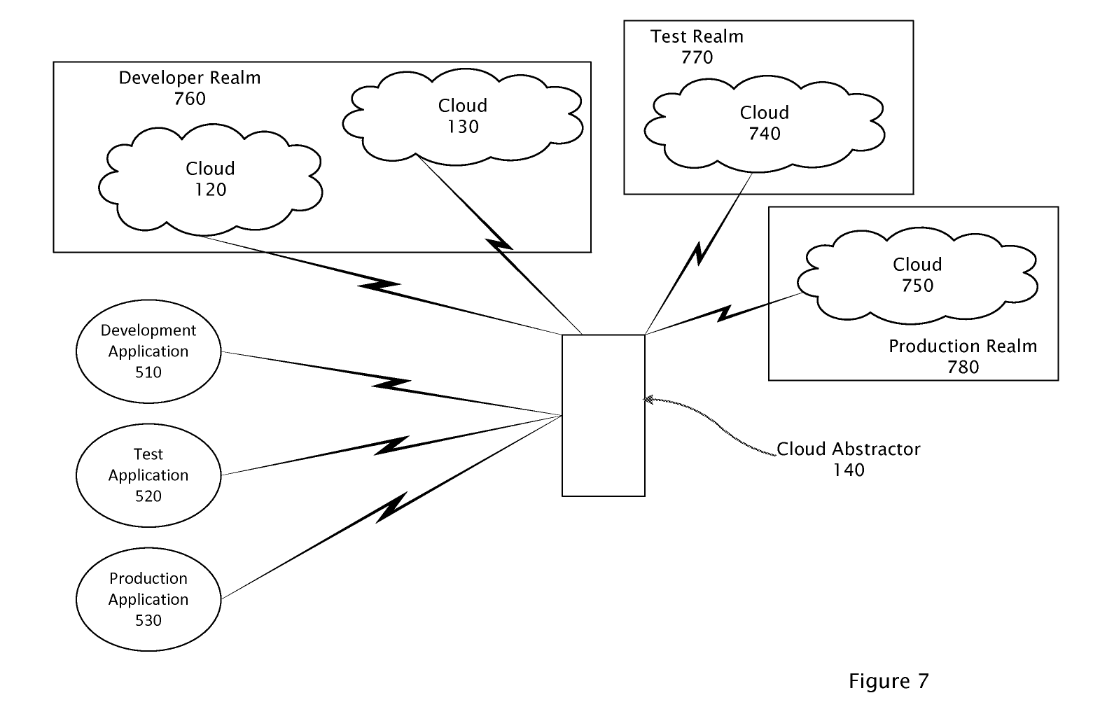

FIG. 7 is an example of one embodiment of realms. In this example, three realms, or personas, are illustrated. A realm is one or more clouds, which may be used for a particular purpose.

In this example, there are three realms: Developer, Test, and Production. Developer Realm 760 comprises Cloud 120 and Cloud 130, while Test Realm 770 comprises Cloud 740, and Production Realm 780 comprises Cloud 750.

A user working on a development project may log in to Cloud Abstractor 140 with a Development Application 510. Cloud Abstractor 140 may be configured to then map calls made by that user to Developer Realm 760. Similar calls made by a user logged in using the Test Application 520 or the Production Application 530 may be translated to Test Realm 770 and Production Realm 780 respectively.

One having skill in the art will recognize that while this example uses one or two clouds for each realm, any number of clouds may be used, with Cloud Abstractor 140 translating to whichever cloud or clouds having the desired resources with desired service level agreements, performance requirements, geography, security options, or any other requirements.

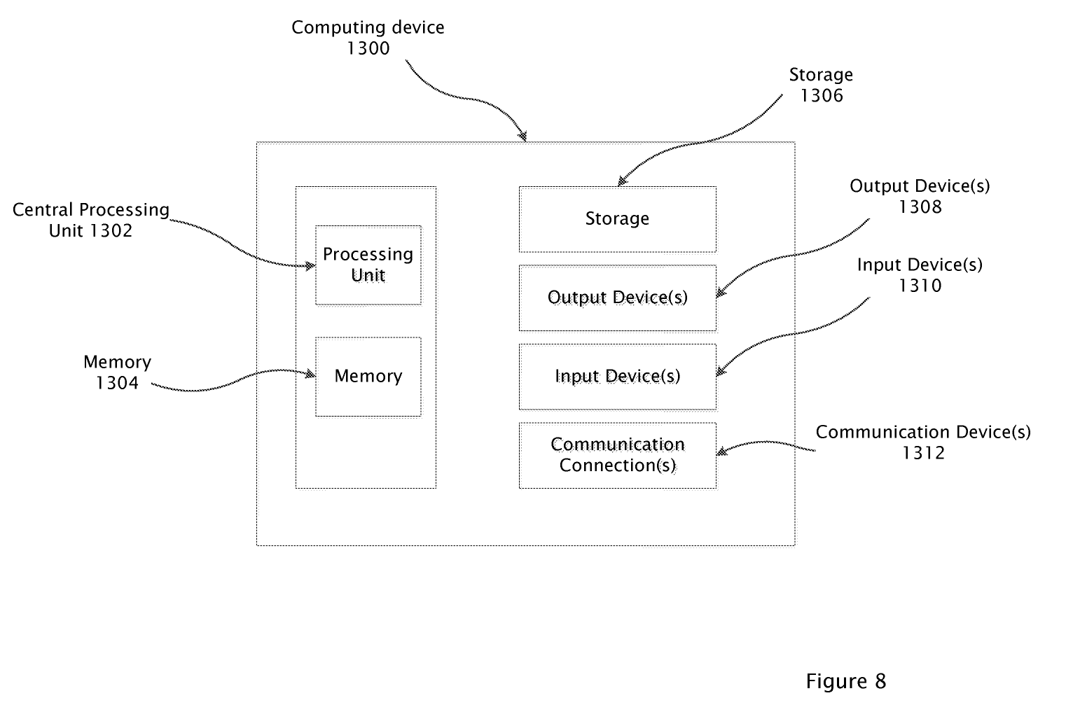

FIG. 8 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a Server (140) or a Client (150). The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 8 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention.

1. A method, comprising:
receiving a first request from a first client device;
selecting a first cloud service to service the first request, the selecting based on the content of the first request;
translating the first request to a format suitable for the first cloud service; and
submitting the translated first request to the first cloud service.

2. The method of claim 1, further comprising:
receiving a second request from the first client device;
selecting a second cloud service to service the second request, the selecting based on the content of the second request;
translating the second request to a format suitable for the second cloud service; and
submitting the translated second request to the second cloud service.

3. The method of claim 1, further comprising:
receiving a first response from the first cloud service; and
sending the first response to the first client device.

4. The method of claim 1 wherein the first request comprises a request for storing data in a database.

5. The method of claim 1 further comprising:
selecting a second cloud service to service the first request;
translating the first request to a format suitable for the second cloud service; and
submitting the translated first request to the second cloud service.

6. The method of claim 5, further comprising:
determining that the first cloud service has failed;
receiving a second response from the second cloud service; and
sending the second response to the first client device.

7. The method of claim 1 wherein the selecting is further based on a characteristic of the first cloud service.

8. The method of claim 7 wherein the characteristic of the first cloud service is performance.

9. The method of claim 7 wherein the characteristic of the first cloud service is selected from a group comprising cost, geographic location, performance, and security options.

10. A computer readable storage medium containing instructions thereon which, when loaded into at least one processor and executed, perform a method comprising:
receiving a first request from a client device;
selecting a first cloud service to service the first request;
translating the first request to a format suitable for the first cloud service; and
submitting the translated first request to the first cloud service.

11. The method of claim 10, further comprising:
receiving a second request from the first client device;
selecting a second cloud service to service the second request;
translating the second request to a format suitable for the second cloud service; and
submitting the translated second request to the second cloud service.

12. The method of claim 10, further comprising:
receiving a first response from the first cloud service; and
sending the first response to the first client device.

13. The method of claim 10 wherein the first request comprises a request for storing data in a database.

14. The method of claim 10 wherein the first request comprises a request for retrieving data from a database.

15. The method of claim 10 further comprising:
selecting a second cloud service to service the first request;
translating the first request to a format suitable for the second cloud service; and
submitting the translated first request to the second cloud service.

16. The method of claim 15, further comprising:
determining that the first cloud service has failed;
receiving a second response from the second cloud service; and
sending the second response to the first client device.

17. A system comprising:
a processor;
a memory coupled to the processor;
a request receiving component configured to receive a first request from a client device;
a first cloud service selecting component configured to select a first cloud service based on the first received request;
a request translating component configured to translate the first received request to a format appropriate for the first cloud service, giving a first translated request; and
a translated request submission component configured to submit the first translated request to the first cloud service.

18. The system of claim 17 further comprising:
a response receiving component configured to receive a first response from a selected cloud service; and
a response sending component configured to send the first response to the client device.

19. The system of claim 17 further comprising:
a fail detection component configured to detect a failure of the first cloud service;
a second cloud service selecting component configured to select a second cloud service based on the first received request;
a request translating component configured to translate the first received request to a format appropriate for the second cloud service, giving a second translated request;
a translated request submission component configured to submit the second translated request to the second cloud service; and
a failover response component configured to respond to a failure of the first cloud service by submitting a second translated request to a second cloud service.

20. The system of claim 17, wherein the first cloud is a private cloud.

21. A method of implementing security, comprising:
receiving a request from a user to access a resource;
authenticating the user;
determining if the user has permission to access the resource; and
if the user has permission to access the resource, generating a security token which allows the user access to the resource.

22. A system for implementing security, comprising:
a processor;
a memory coupled to the processor;
a request receiving component configured to receive requests from a user for a resource;
a determining component configured to determine if a user has permission to access a resource;
a granting component configured to generate a token to allow the user access to the resource.

23. A computer readable storage medium containing instructions thereon which, when loaded into at least one processor and executed, perform a method comprising:
receiving a request from a user to access a resource;
authenticating the user;
determining if the user has permission to access the resource; and
if the user has permission to access the resource, generating a security token which allows the user access to the resource.
